(19) United States
(12) Patent Application Publication
(10) Pub. No.: US 2013/0332240 A1
(43) Pub. Date: Dec. 12, 2013

(54) SYSTEM FOR INTEGRATING EVENT-DRIVEN INFORMATION IN THE OIL AND GAS FIELDS

(71) Applicants: Om Prasad PATRI, Los Angeles, CA (US); Vikrambhai S. SORATHIA, Los Angeles, CA (US); Viktor K. PRASANNA, Los Angeles, CA (US)

(72) Inventors: Om Prasad PATRI, Los Angeles, CA (US); Vikrambhai S. SORATHIA, Los Angeles, CA (US); Viktor K. PRASANNA, Los Angeles, CA (US)

(73) Assignee: University of Southern California, Los Angeles, CA (US)

(21) Appl. No.: 13/492,430

(22) Filed: Jun. 8, 2012

(51) Int. Cl. G06Q 10/06

(52) U.S. Cl. 705/7.36

(57) ABSTRACT

A complex event processing system includes a complex event processing engine configured to detect one or more events across a plurality of data sources and provide a corrective action. The complex event processing system further includes an ontology repository in communication with the complex event processing engine, the ontology repository being configured to receive a first semantic query from the complex event processing engine. The complex event processing system also includes an enterprise integration pattern library in communication with the complex event processing engine, the enterprise integration pattern library being configured to receive a second semantic query from the complex event processing engine.

### FIELD

The present invention pertains in general to computation methods and more particularly to a computer system for integrating event-driven information in the oil and gas fields.

### BACKGROUND

Several operations in the Exploration and Production (E&P) sector are event-driven in nature and are supported by specialized systems and applications. Narrow focus of applications results in application silos that restrict the information sharing across verticals, which is a critical requirement for coordinated cross-functional efforts. Effective response to events warrants due emphasis on an integration strategy that facilitates desired information flow across verticals. Event-driven methods can be used to make strategic asset management decisions across silos in real-time, thus reducing response time and costs while improving asset performance.

Various integrated operations strategies have been explored for enterprise information integration in the oil and gas industry. An event-driven approach accounts for a significant part of operations in the E&P sector. For instance, most repair and maintenance tasks are scheduled in response to failure events, which are usually accompanied by anomalies in realtime data streams. The production, operations, maintenance and other related teams respond to events by appropriately utilizing vendor products that are capable of effectively handling specific aspects of the events. Limited scope of such systems results in application silos that inhibit information sharing across relevant verticals. Thus, they suffer from several drawbacks—most notably, that of not having an integrated and consistent view of the situation in realtime. For example, in order to access the job history, maintenance information and equipment data after a tubing failure, an engineer might have to query multiple heterogeneous data sources for the data and then manually integrate the resulting information.

Complex event processing (CEP) is an emerging research area that involves detecting complex events, processing the events, deciding actions for each event and notifying the relevant personnel about the event. Complex event processing (CEP) is an evolving field of interest in computer science and related disciplines. It encompasses detection and processing of complex events, decision of actions for each event and sending notifications to relevant personnel. It has been used for a wide range of applications such as algorithmic trading, business process management and sensor networks. CEP is particularly deemed to be useful for enterprise integration scenarios, involving isolated components, multiple data sources and high throughput of events. Several commercial as well as open-source software tools are available to facilitate CEP. However, current CEP systems are not able to efficiently integrate event information from multiple, heterogeneous data sources and to exploit the power of a knowledge base for processing.

Therefore, there is a need for a CEP system that cures the above and other deficiencies of conventional CEP systems.

### SUMMARY

An aspect of the present invention is to provide a complex event processing (CEP) system. The CEP system includes a complex event processing engine configured to detect one or more events across a plurality of data sources and provide a corrective action. The CEP system further includes an ontology repository in communication with the complex event processing engine, the ontology repository being configured to receive a first semantic query from the complex event processing engine. The CEP system also includes an enterprise integration pattern library in communication with the complex event processing engine, the enterprise integration pattern library being configured to receive a second semantic query from the complex event processing engine.

Although the various steps of the method according to one embodiment of the invention are described in the above paragraphs as occurring in a certain order, the present application is not bound by the order in which the various steps occur. In fact, in alternative embodiments, the various steps can be executed in an order different from the order described above or otherwise herein. For example, it is contemplated to transform from, the first model to the second model, or vice versa; or to transform from the third model to the second model, or vice versa; or yet to transform from the third model to the first model, or vice versa.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. In one embodiment of the invention, the structural components illustrated herein are drawn to scale. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

In the accompanying drawings:

FIG. 1 is a diagram showing various components that may be involved in a production optimization case, according to an embodiment of the present invention;

FIG. 2 is a diagram showing various aspects of an event correlation for a pump failure, according to an embodiment of the present invention;

FIG. 3 is a flow diagram of a semantic complex event processing (CEP) architecture or system for the digital oilfield or gas field, according to an embodiment of the present invention;

FIG. 4 depicts an example of a sequence of possible integration patterns for a user query, according to an embodiment of the present invention;

FIG. 5 is a flow diagram showing an event escalation scenario, according to an embodiment of the present invention;

FIG. 6 is a time flow diagram depicting how proactive CEP leads to reduced delays and quicker response times, in various scenarios, according to an embodiment of the present invention;

FIGS. 7A and 7B are flow diagrams showing the data seeking effort by users without and with using a CEP engine, respectively, according to various embodiments of the present invention;

FIG. 8 is a flowchart depicting a management by exception scenario with the use of the CEP-based system, according to an embodiment of the present invention; and

FIG. 9 is a schematic diagram representing a computer system for implementing the methods or systems, according to an embodiment of the present invention.

### DETAILED DESCRIPTION

One notion to the vision for a digital oilfield or gas field is that of ‘management by exception’. This refers to analyzing the data and alerting the relevant personnel only in case of a critical or error situation, and not overloading the personnel with redundant information. Realizing this concept involves matching patterns to detect events, filtering irrelevant events, assigning priority to events, notifying critical events to corresponding users and customizing results according to user preferences. All these tasks need to be accomplished across heterogeneous, distributed data sources and with minimal delay. An event-driven architecture can realize these requirements through a complex event processing framework.

Consider a typical application scenario such as a pump failure event in an oilfield, which should elicit response not only by the pump operator but also by the maintenance engineers, production managers, reservoir engineers and other involved personnel. A proactive event-driven system enables quick detection of the failure across heterogeneous data sources and takes corrective actions while notifying the appropriate personnel. This facilitates effective communication across the teams and software systems involved.

An event-driven architecture can provide a unified view of multiple knowledge sources and serve as a single query endpoint for the user, reducing the data seeking effort. This would eliminate the application silos present in the Exploration and Production (E&P) industry, which are major roadblocks for any integration operation.

In one embodiment, a method for complex event processing (CEP) for facilitating information integration for the Exploration and Production (E&P) is provided. The method can be used, for example, to improve asset performance and make strategic decisions while reducing response time and costs.

For example, the E&P sector has several verticals that are event-driven, such as operations, market policies, production, regulation, management and safety, health and environment (SHE), etc. For example, production optimization can be selected to examine event-driven factors and their effects across an organization. A similar approach can be followed for other verticals in the E&P sector such as real-time field surveillance and well services management, etc.

Production optimization refers to the process of monitoring production in the field and taking appropriate actions to maximize production. These actions may be short-term, such as regulations of valves and adjustment of sensors with the wells, or long-term, like replacing equipment and drilling new wells. An integrated operations strategy would be useful for achieving realtime production optimization. However, there are several roadblocks to an effective solution. These roadblocks include information overload, uncertainty of measurements, discrepancy between local and global optimums, as well as health, safety and environment risks.

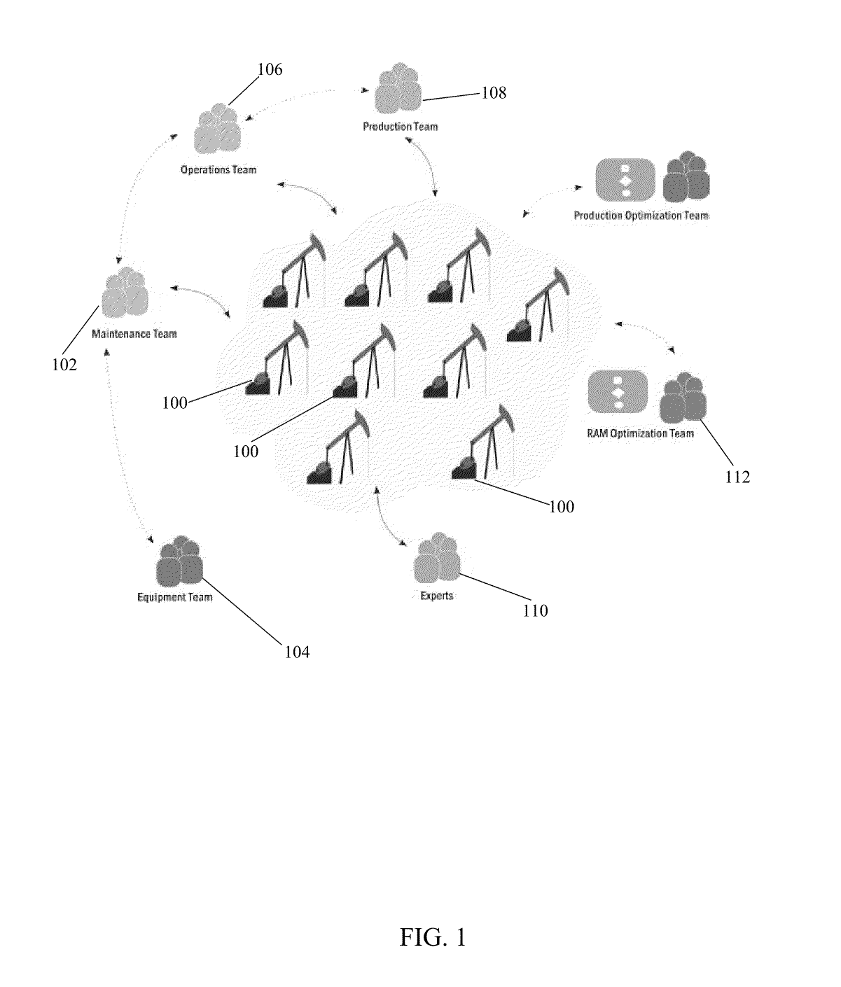

FIG. 1 is a diagram showing various components that may be involved in a production optimization case, according to an embodiment of the present invention. Data can originate from several distributed sources such as historian systems, maintenance systems associated with maintenance team 102, equipment databases associated with equipment team 104, operations systems associated with operation team 106 and well information systems associated with production team 108. Corporate social networks, collaboration platforms and technical discussion boards are also useful information sources but are typically ignored in most enterprise integration systems. Each of these sources has ‘roles’ for corresponding personnel or software systems, which can write data into a relevant data source. These systems also act as interfaces for other personnel or software systems needing to read data from the resource. These systems can be categorized as ‘knowledge sources’. The involved personnel which include operators, technicians, engineers, workers, analysts and managers at several levels of the organizational hierarchy, are usually categorized into teams. Each team interacts with corresponding system(s), records relevant information and uses it for future reference. For instance, the maintenance team 102 is concerned with the maintenance and job history information, the operations team 106 is associated with a well information system, experts 110 determine injection rates, the reliability, availability and maintainability (RAM) team 112 is monitoring real-time equipment status, and the production team 108 is associated with production monitoring tools. The incoming data typically also includes a continuous realtime stream of information, such as sensor and valve measurements and equipment status.

For example, when a pump failure event occurs in the oilfield, this event has various ramifications. The ramifications of this event are not limited to any one data system or team, but distributed throughout the organization. The failure event is associated with some equipment (i.e., the pump 100), the data about which is in the equipment database. Also, previous job history on the same equipment can provide significant indicators to the cause of failure. Pump 100 is also associated with a certain rig, area and field. Such background knowledge may be captured and incorporated for resolving the failure event. The list of personnel who should be informed about the event can also be identified. Employees might discuss about the failure on technical discussion boards or micro-blogging sites and receive solutions to their queries from experts 110. Such question-answering information is useful to suggest answers to similar future problems. In addition, the effect of the failure event on operations and production schedules can be estimated to decide how critical the failure is, and therefore update the production schedule. For example, a minor failure in a major oilfield or gas field can be more critical than a major failure in a smaller oilfield or gas field. Hence, other contextual information may also be used. The information to be collected about the event is located in multiple knowledge sources. Hence several isolated queries to various software systems and teams may be needed to obtain all the relevant data. The complexity of these inter-relationships results in longer downtimes and increasing losses to overall production. Therefore, an effective integration solution is required.

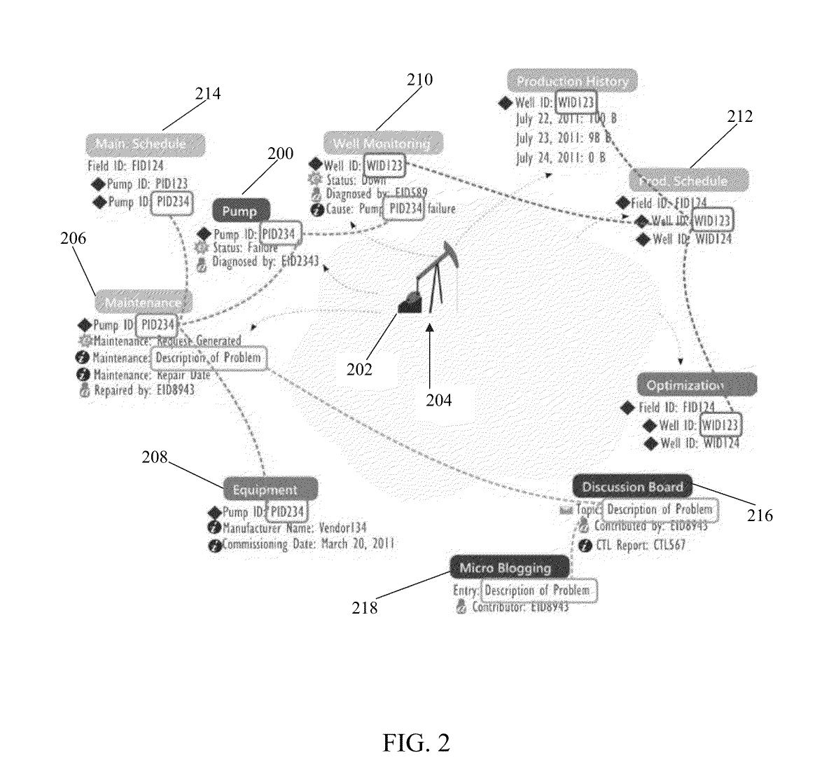

FIG. 2 is a diagram showing various aspects of an event correlation for a pump failure, according to an embodiment of the present invention. For example, pump 200 with unique identifier PID234 has failed. Pump 200 is associated with well 202 with identifier WID123 in the field 204 with identifier FID124. The information about the failure of pump 200 is recorded in the pump maintenance system 206 under PID234, in equipment database 208 under PID234, in well monitoring system 210 under WID123. In addition, the failure of pump 200 may lead to changes in the maintenance schedule 214 and production schedule 212 ultimately affecting production. This information is stored in separate systems every time changes are made to data sources.

A typical SQL query on traditional databases may not be sufficient to query the complex relations from multiple systems and correlate the results. This is because SQL queries only perform syntactic matching and fail to use semantics of the involved entities. For example, a SQL query cannot determine (without any background knowledge) that a pump is associated with a corresponding well, which are both part of a field.

To capture these correlations and represent them effectively across heterogeneous data sources, semantic web technologies are used. A semantic representation model can capture the necessary background knowledge such as the data mappings/correlations among different assets and personnel. Some benefits provided by a semantic approach are interoperability between multiple data sources, rich expressiveness in representation and added dynamism in the framework. The added dynamism with help of the background knowledge helps in intelligent pattern detection, reasoning, rule selection, action determination and notification processes. The semantic framework provides the supplemental contextual information for the production optimization use case.

The concept of “management by exception” may enable contextual filtering of events and reporting only those events that are relevant to appropriate personnel, thus avoiding information overload. For example, critical events would be given more priority and placed higher in the report for immediate attention. The user may even be able to modify the reported event priorities and send feedback to a notification system for better reports. In addition, corrective actions for failure of the pump 200 can be determined automatically from a pre-defined knowledge base and suggested to corresponding persons. Moreover, the system can also include forecasting capabilities to predict when the pump 200 will fail in the future and take relevant actions before failure occurs (such as sending a notification to the concerned engineer), thus reducing response time and delays.

Different users may be interested in different events and viewing data at specific event granularities. Hence, the system may be provided with multiple hierarchical views to account for the different granularities. The different granularities may be in a temporal or spatial dimension. For example, a data entry operator may want to look at every single reading on a sensor in a pump. On the other hand, a maintenance engineer may only want to view the readings just before and after a failure event. A manager may only want to look at the average daily readings of the sensors for all pumps in the region, and the production supervisor may just want to know the average monthly production from all wells based on the sensor readings.

These features of the system can be implemented using event-based architectures and messaging infrastructures. Complex event processing systems provide the detection, filtering, analysis, prediction and notification capabilities required for the integrated system. Typically, events are preceded by certain conditions and followed by certain actions.

An example of a simple event-condition-action rule can be “On tank level above 100, if the pump is down, alert the operator about pump failure event”. In this rule, the event is ‘tank level above 100’, the condition is ‘pump is down’ and the action is to ‘alert the operator’. The tank level reading may be obtained from typical historian systems, and the coordinates of the engineer to be alerted can be obtained from the maintenance database or the engineer's profile in the organizational hierarchy.

A more complex event may require combining information from several simple events. For instance, the rule “If the average tank level for the last hour exceeds the average tank level for the last month for all pumps in the Western region by 20%, and if this event happens within 1 hour of a pump failure, look up best practices for dealing with the issue, estimate how critical the event is and its effects on the production schedule, and send alerts to appropriate personnel” includes information about domain knowledge from multiple data sources, over a range of spatial and temporal dimensions. Further, it is related to another event, i.e. ‘pump failure.’

Specifically, it is possible to correlate the same pump failure event being recorded in multiple knowledge sources like maintenance database 206, operations database 210 and equipment database 208 as well as technical discussions board 216 and/or micro-blogs 218 where the failure is discussed. Once the event is detected, the knowledge base can be queried and corrective actions can be suggested such as checking for gas leaks, adjusting the readings on a certain sensor, decreasing the oil or gas flow rate or replacing the malfunctioning equipment. Smart notification systems can transmit appropriate notifications and suitable data analytics approaches can forecast future failures and issue warnings before failures occur. In one embodiment, best practices specific to an organization may also evolve from the observed patterns of events and actions taken.

Event-based information systems have the concept of ‘events’ at the core. An ‘event’ is defined as ‘anything that happens, or is contemplated as happening.’ These events can be combined and processed to give rise to ‘complex events.’ For instance, ‘tank level rises above 100’ is a simple event, while ‘tank level rises by 10% from yesterday's average value within 2 hours of a pump failure’ can be considered a complex event. Event processing systems consider that the event passes through various ‘event states’, from its inception to deletion. An ‘event profile’ is a condition that is continually evaluated by the system against the trace of incoming events. A continuous sequence of events can be termed as an ‘event stream’. A person or system responsible for executing the event action is known as an ‘actor’. Complex event processing (CEP) refers to operations on complex events such as detection, transformation, filtering, action determination and event-based notification. Semantic complex event processing refers to the use of a semantic knowledge base enabling complex event processing (CEP).

Conventional database or web-querying systems view data as static, the static data receiving a continuous stream of queries. On the other hand, event processing systems are suited for a scenario that has a static set of queries to be applied over a continuous stream of incoming data. The incoming data stream may be preprocessed or transformed to enrich it for the event processing system.

In one embodiment, this enrichment is performed semantically by using background information from the knowledge base. Complex event detection refers to processing simple events and using predefined rules to detect complex events. For example, a complex event detection rule may state “If event B happens within 10 minutes after event A and event C has not started, then infer the complex event Z.” Usually these rules are in the form of event-condition-action rules as described above. These rules can be obtained from domain experts and integrated into the CEP system, which, in the course of time, may discover additional rules.

Dynamic rule selection based on context may also be part of the integration framework. Based on the chosen rules, event action determination is the next step after detection. In this case, event-condition-action rules can also help in making decisions and this information is communicated to the actor (i.e., entity taking the action).

Notification is also part of the CEP system. The specific messaging channel and method used may vary. However, a pattern is to use the publish-subscribe paradigm. Subscribers subscribe to select topics of their interest from a list, and whenever a new message is published under a topic of interest, all subscribers of that topic are notified. In one embodiment, information from the enterprise social and collaboration networks can be used to identify these topics and user-topic mappings. Information from the social network is also valuable for finding persons with specified job descriptions and qualifications. These mappings can be used to automatically generate a list of subscribers on the runtime based on content and context of a message. Therefore, instead of a fixed, static subscription list, the list can be transient, dynamic, and smart. An event broker or mediator is an entity that is responsible for deciding which route a message should take to reach its appropriate destination.

Advances in predictive analytics have enabled efficient use of historical and background knowledge for event forecasting, especially for anomaly detection. In case a failure is predicted, a smart-list of concerned personnel can be generated dynamically and the personnel can be notified with suggested actions to avoid the failure. As the CEP system goes through various iterations, the CEP system can learn to find optimal values and tune several parameters involved in a model. Contextual filtering capabilities may also be implemented in the CEP system to remove redundant information and avoid data overload.

Enterprise integration patterns are guidelines for describing solutions to frequently occurring problems. The intention of using these patterns is to unify the high-level vision of integration with the actual system implementation. These patterns lead to the design of an efficient messaging architecture. For instance, if it is observed that a set of events have to be combined and divided frequently for a certain kind of processing, aggregator and splitter patterns can be used. When used effectively, such patterns lead to a more concise representation as well as a standard for making strategic decisions in the future. As a result, the gap between the high-level integration view and the actual implementation can be reduced. In one embodiment, enterprise integration patterns can be included as a core component of the complex event processing system.

A core concept contributing to popularity of messaging systems is that of ‘loose coupling.’ The idea is to reduce the assumptions two components of a system make about each other when they exchange information. This leads to asynchronous communication architectures with provisions for handling interruptions, changes or anomalies because the two components are not tightly coupled.

In one embodiment, there are three broad types of integration patterns are message routing patterns, message transformation patterns and message management patterns. Message routing patterns include patterns such as content-based router, message filter, splitter, aggregator, re-sequencer, or composed message processor, or any combination thereof. Message transformation patterns include content enricher, content filter, message translator, envelope wrapper, claim check, or normalizer, or any combination thereof. Message management patterns include patterns such as wire tap, control bus, message store, channel purger, detour, or message history, or any combination thereof.

In order to detect complex events, the CEP system determines if certain actions have occurred. This can be achieved by creating transient patterns that can poll data values. In addition, if there is no response from the data source for a certain time period, then alternative ‘event escalation’ patterns can be triggered to replace the previous patterns.

In one embodiment, as will be described further in detail in the following paragraphs, an event-driven information integration framework or CEP system has three major components: (i) ontology repository, (ii) CEP information bus and (iii) CEP engine. In one embodiment, A data access component is used by the end-user to interact with and query the CEP system, and a plugin/web service can also be provided. In one embodiment, the system further includes an EIP library.

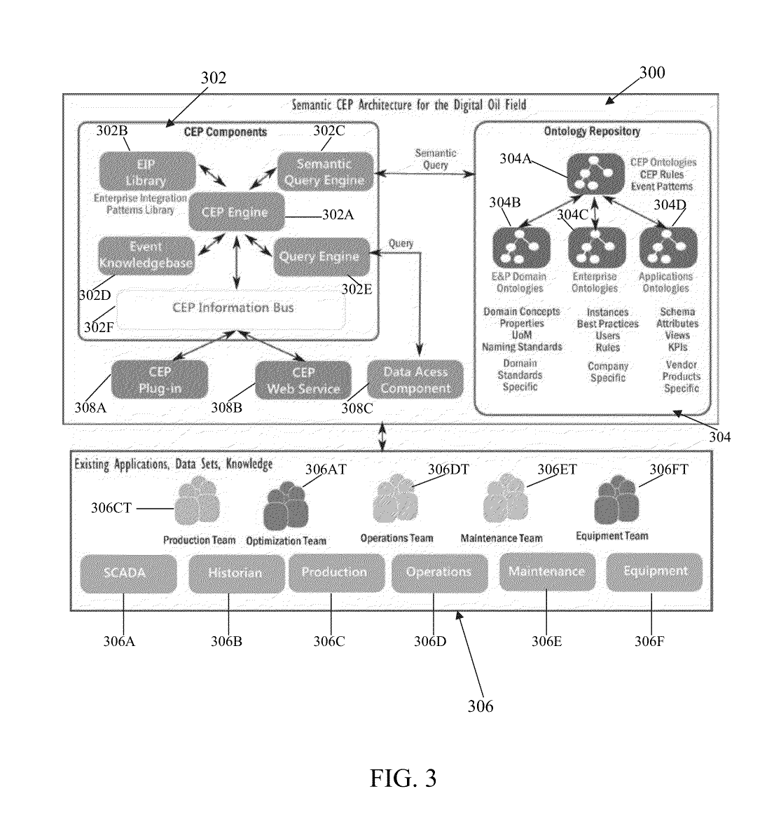

FIG. 3 is a flow diagram of a semantic CEP architecture or system for the digital oilfield or gas field, according to an embodiment of the present invention. The semantic CEP architecture 300 includes CEP components module 302, knowledge base or ontology repository module 304 and existing information sources 306. The CEP components module 302 include a CEP engine 302A, enterprise integration patterns (EIP) library 302B, semantic query engine 302C, event knowledge base 302D, query engine 302E, and CEP information bus 302F. The CEP engine 302A communicates with the EIP library 302B, semantic query engine 302C, event knowledge base 302D, query engine 302E and CEP information bus 302F. The CEP information bus 302F in turn communicates with CEP plug-in 308A, CEP web service 308B and data access component 308C. The CEP components module 302 communicates with and sends queries to data access component 308C. The ontology repository module 304 includes CEP ontologies component 304A (including CEP rules and event patterns), domain ontologies 304B (including domain concepts, properties, naming standards which are domain standards specific), enterprise ontologies component 304C (including instances, best practices, users' rules which are company specific), and applications ontologies component 304D (including schema, attributes, views, key performance indicators or KPIs which are vendor products specific). Component 304A communicates with components 304B, 304C and 304D. Existing information sources 306 represents information from various knowledge sources including supervisory control and data acquisition (SCADA) database 306A, historian database 306B, production database 306C, operations database 306D, maintenance database 306E, or equipment database 306F, or any combination thereof. These databases are under the control of various teams such as production team 306CT, optimization team 306AT, operations team 306DT, maintenance team 306ET, and equipment team 306FT, respectively.

Existing information sources 306 comprise information from all data sources 306A-F. In the integrated CEP architecture, the data access component 308C serves as a single endpoint for reading data from the information sources 306, which include oilfield or gas field assets as well as the personnel involved. A user may be able to query this single resource 308C instead of multiple databases, ontologies and the collaborative social network. Whenever realtime information needs to be read from an individual data source (e.g., SCADA database 306A or database 306C, etc.), the data access component 308C can provide an updated copy of the data source and the appropriate information can be read.

In one embodiment, integrated ontology repository or knowledge base 304 is used to provide this unified view of the existing information sources 306. Ontology repository or knowledge base 304 is configured to go beyond syntactic methods and enables semantic approaches for analysis and representation of data from the knowledge sources (e.g., 306A, 306B, . . . , 306F). The creation of ontology repository 304 would entail schema matching and ontology mapping between the individual data sources 306A-306F. As described above, the ontology repository 304 has a modular structure and contains four sets of ontologies components (ontologies components 304A-304D).

CEP ontologies component 304A provides the schema for events, entities, processes, roles, states, integration patterns, rules, observations, situations, or other required event-based integration components independent of any domain concepts, or any combination thereof. The CEP ontologies component 304A maps generic concepts such as time and space from public upper ontologies. The CEP ontologies component 304A belongs to a set of domain/task ontologies in a hierarchy from which application ontologies can be derived. Existing event ontologies are either too domain specific to act as generic CEP ontologies, or do not incorporate additional features in semantic CEP such as enterprise integration patterns and event detection across multiple sources. CEP ontologies component 304A is generated by combining common concepts needed to enable a CEP framework.

Event Entity is either a physical entity or an abstract entity. Physical entities include, for example, all kinds of equipment, machinery and humans. An event state refers to started, stopped, failed, working, etc. An event role is classified as an event producer, an event consumer, a subscriber, a publisher, an employee, a supervisor, a manager, an actor, etc. The concept of event observation encompasses various measurement details about the observations, frequency of observations, system reporting the observation. An event refers to simple or complex events. Complex events are able to combine information from several simple events. An event process refers to event processes such as event detection, action, or notification. Integration patterns contain a list of enterprise integration patterns used. Event Rules contain various types of rules such as ECA rules, action determination rules and event escalation rules.

Domain ontologies component 304B has exploration and production (E&P) domain concepts, naming standards, unit of measures and other domain-specific information. To build this set, information from domain standards like the PPDM™ data model and the ISO 15926 standard are used, which can act as domain ontologies. The set is mapped as desired. For instance, the naming conventions for a well, units of measure used, or attributes of a pump, or any combination thereof are found in this set of ontologies.

Application ontologies component 304D is specific to vendor-supplied applications and contain information about key performance indicators (KPIs), equipment attributes, or application views and schema for other vendor-specific items, or any combination thereof. This information can usually be obtained from data sources such as computerized maintenance management systems (CMMS), historian systems, operations and production databases. For instance, a maintenance system typically has KPIs such as barrels of oil produced per day (BOPD) or volume of gas per day, expected downtime and net production, which can be found in this set of ontologies.

Enterprise Ontologies component 304C is a specialized set of enterprise ontologies which capture information specific to the enterprise, such as business rules, employee data, preferred schedules, best practices, company policies, and any other company-specific information. Example of information found in these ontologies includes the organizational hierarchy, supervisor relations, employee IDs, staff email addresses, or team compositions, or any combination thereof. The information for this set of ontologies is derived from the information provided by the enterprise.

Apart from representational benefits, this model for the integrated ontology repository is very adaptive and can easily be made more generalized or specialized, as desired. Since the CEP ontology component 304A does not contain any domain related concepts, it is possible to adapt the model to a completely new domain (instead of oil and gas) by modifying the bottom tier ontologies. To use the same structure for another organization, one may change information in the enterprise ontologies (and domain ontologies if domain is different) without affecting the other ontologies.

There are several methods for information communication in an enterprise integration scenario. However, messaging systems may provide several benefits. For example, messaging systems can reduce delays in communication because of their asynchronous, loosely coupled nature and can be used to reliably communicate information through an information bus in realtime. Messaging systems enable effective remote communications between components and ‘remote operations,’ which may be central to integrated operations capabilities. Messaging systems are particularly useful for enterprise integration scenarios involving several platforms and programming languages. Examples of enterprise integration scenarios and patterns can be found in “Enterprise Integration Patterns: Designing, building, and deploying messaging solutions,” by Hohpe, G. and Woolf, B., 2003, Addison-Wesley Longman Publishing Co., Inc., the entire contents of which is incorporated herein by reference. Messaging systems act as mediators for conveying and communicating information between diverse enterprise components. For example, smart information bus, such as CEP information bus 302F, can effectively serve as a channel to harness the power of messaging systems to input or output data into and from the CEP engine 302A.

In one embodiment, based on background knowledge from the ontology repository 304, the best sequence of integration patterns for a certain situation can be determined. These dynamic integration patterns correlate information from diverse existing information sources (e.g., 306A-306F).

This approach provides various benefits including (i) exploiting the power of semantic technologies for improved representation and inference over events, and (ii) generating corresponding patterns dynamically based on the content of the query with help from the ontology repository 304. Therefore, all patterns chosen by the CEP engine 302A are transient patterns and would keep evolving based on the current query context.

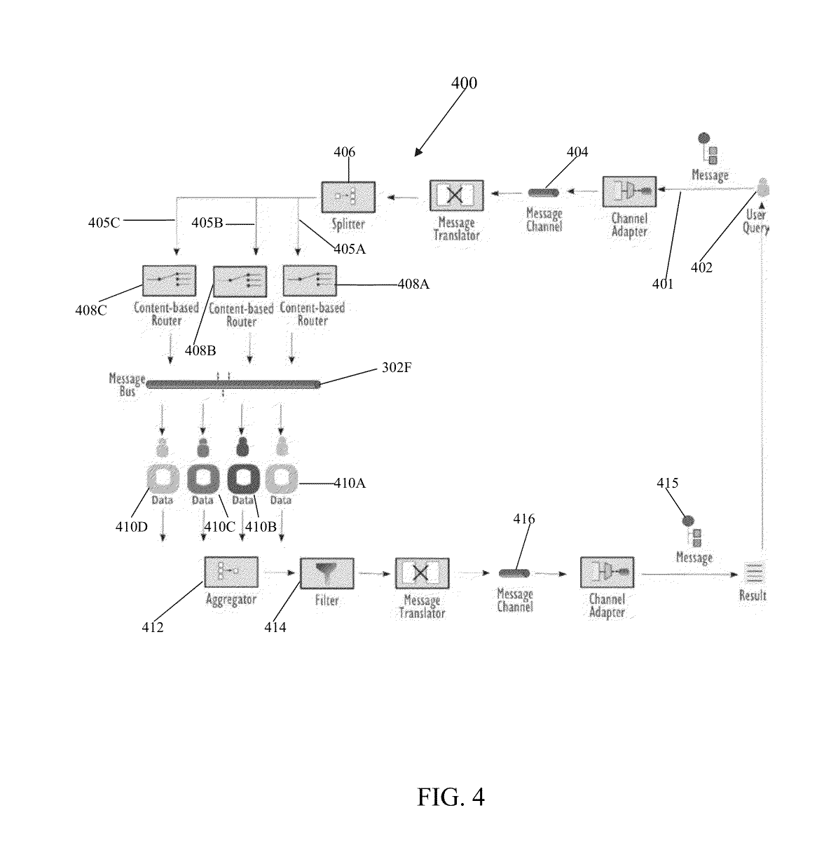

FIG. 4 depicts an example of a sequence 400 of possible integration patterns for a user query, according to an embodiment of the present invention. The data access component 308C provided for the user is connected to the CEP information bus 302F and thus, the CEP engine 302A, which implements most of the desired functionality.

First, a query 401 from a user 402 is prepared for transmission through a message channel 404. The query is split into sub-queries 405A-405C using splitter 406 according to the target data source to be queried. Content-based message routers 408A-408C direct the sub-queries 405A-405C to the messaging bus 302F. The messaging bus 302F redirects the sub-queries 405A-405C to appropriate data sources 410A-410D, such as for example, production database 306C, operation database 306D (shown in FIG. 3). Result datasets are then aggregated using aggregator 412 and filtered using filter 414 to remove portions from the result datasets and refine the result datasets according to the preferences and granularity desired by the user. Finally, the resulting information is sent as a message 415 through message channel 416 back to the user 402. Based on content of the user's query and background knowledge, the CEP engine 302A can automatically determine this sequence of integration patterns for a certain time period.

Current well information systems like LOWIS™ have a system of web reports for notifications. However, these notification systems have fixed pre-defined subscription lists and cannot create these lists automatically from background knowledge. In one embodiment, knowledge-based smart notifications can be made through the event processing system 300 in which the list of subscribers is also decided dynamically. For instance, an engineer does not need to keep reading the tank level at every minute to know if the pump is down, or is expected to go down soon, and time is not spent deciding which personnel are to be alerted in case of a critical pump failure.

The semantic CEP engine 302A is at the core of the integration framework or CEP system and includes components handling various aspects of processing events. With help from the integrated ontology repository 304, the engine 302A is able to detect events across multiple data sources (e.g., data sources 306A, 306B, . . . , 306F) and correlate siloed happenings to the same event. The CEP engine 302A is able to handle a high throughput of events in realtime with contextual filtering capabilities to retain only those simple events which lead to detection of complex events. Event-Condition-Action rules from domain experts may also be helpful in complex event detection. After detection, the CEP engine 302A can suggest corrective actions for the corresponding event to the appropriate personnel. Through predictive analytics methods, reasoning and access to historical data, the CEP engine 302A can predict future failure events. A smart notification or reporting system can be used for disseminating information from the CEP engine 302A to the users and vice-versa. This notification system can decide, on the fly, the list of subscribers to whom the message should be sent. At all times, the CEP engine 302A can customize its reports to the preferences and granularity of the users concerned.

As the CEP engine 302A undergoes several iterations of complex event processing, certain enterprise integration patterns (EIP) will be noticed from the complex event rules. For example, as stated in the above paragraphs, message routing patterns include patterns such as content-based router, message filter, splitter, aggregator, re-sequencer and composed message processor. For instance, it may be observed that ‘aggregation’ of events A and B and then splitting into components C, D and E is a frequent pattern. This sequence of integration patterns is then automatically identified and used for the corresponding scenario in the integration framework. Enterprise integration patterns are guidelines for describing solutions to frequently occurring problems. The intention of using these patterns is to unify the high-level vision of integration with the actual system implementation. In one embodiment, enterprise integration patterns can be included as a core component of the complex event processing system. The enterprise integration pattern (EIP) library 302B contains all the integration patterns used by the CEP engine 302A.

In one embodiment, the CEP engine 302A is configured to determine integration patterns needed for processing specific events, and to retrieve the integration patterns from the enterprise integration pattern library 302B. In one embodiment, the enterprise integration pattern library 302B is configured to manage a lifecycle of integration patterns during a complex event process.

In one embodiment, the event knowledge base 302D is generated by performing data mining on semantically enriched data retrieved from the enterprise data sources. The enrichment is performed in the event knowledge base 302D using background knowledge from the ontology repository 304. The event knowledge base 302D contains information about possible types of events in the enterprise and the way these events are related to other resources such as individuals, teams, schedules, roles, processes and key performance indicators. The existence of this event knowledge database 302D enables semantic complex event processing.

In one embodiment, the query engine 302E is configured to execute SQL queries over one or more relational databases, which cannot be incorporated into the semantic ontology repository 304. This is because some databases such as 306A-F may contain instantaneous data being updated constantly, and reflecting these data instances in the ontologies may cause the databases 306A-F to be overloaded with data. Thus, the schema for the data is obtained from the ontology repository 304 by semantic queries and the instantaneous data values are obtained from existing information sources 306 by SQL queries. These SQL queries are managed and communicated by the CEP engine 302A. Complex queries are usually broken into sub-queries based on content, and intelligent selection of the sequence of integration patterns by the CEP engine 302A drives query processing. The results of the query are returned to the CEP engine 302A with the desired granularity.

In one embodiment, the CEP engine 302A generates and manages semantic queries to be executed over the ontology repository 304 for inferencing and reasoning. The semantic query engine 302E is responsible for executing these queries and communicating the results back to the CEP engine 302A. SPARQL query language can be used for semantic querying over ontologies.

A semantic query may read information from multiple data sources or ontologies in ontology repository 304. This can be illustrated in the following query, which needs information from different modules in the ontology repository. The concepts related to time are obtained from the CEP ontology (co) 304A, the failure event and status is obtained from the application ontology (ao) 304D, while the best practices for a certain failure event are extracted from the enterprise ontology (eo) 304C. This capability is not achievable without a semantic query system.

The query is based on the components and notation shown in FIG. 2. It is assumed that query elements are previously defined in the ontologies. Given certain specifications such as failure reason, failure area, start time and end time, the query returns instances of failure events, their status, associated equipment information and best practices.

An example of a semantic query can be as follows:

```
SELECT ?failureEvent ?equipmentID ?wellID ?status ?bestPractice
WHERE {
  ?failureEvent ao:hasFailureReason ao:pump_failure .
  ?failureEvent ao:hasEquipmentID ?equipmentID .
  ?failureEvent ao:hasRelatedWell ?wellID .
  ?failureEvent ao:hasFailureArea eo:FID124 .
  ?failureEvent ao:hasFailureStatus ?status .
  ?failureEvent eo:hasBestPractice ?bestPractice .
  ?failureEvent co:hasStartTime ?stTime .
  ?failureEvent co:hasEndTime ?endTime .
  FILTER(?stTime > (co:now-90) && ?endTime < co:now)
}
Sample Result:
  E1442346  PID234  WID123  DOWN  Replace_valve
```

In one embodiment, the data access component 308C is independent of the internal architecture of CEP engine 302A. When triggered by the CEP engine 302A, the data access component 308C fetches instantaneous information from the individual information sources 306A-F, such as production database, historian and SCADA systems. The CEP engine 302A contains the configuration details and retrieval logic for each individual information source 306A-F. In case of event, the user is expected to manually determine when and how to access information from the various information sources 306A-F in absence of CEP engine 302A configured appropriately with data access component.

In one embodiment, for ease of use and adoption, the CEP-based integration framework system can be implemented as a plugin to popular software tools already being used by personnel in the domain. The plugin can be provided with sufficient features to account for all end-user activity. One part of this plugin is visualization of the integration process with multiple contextual views, which is missing from conventional systems. This context can be multiple granularities of a temporal, spatial or other contextual parameter. A CEP web service 308B would provide easy web access to the features enabled by the integration framework of the CEP system. Such plugin and web-service components 308A and 308B would constitute the user interface and the user accessible components of the CEP system.

For example, in a pump failure case, a user may send various query statements to interact with the CEP engine 302A. The query statements pertain to the information in FIG. 2 and the semantic query described in the above paragraphs. For example, the query statements may include:

(a) Find all pump failures in field FID124 with downtime greater than 90 minutes.

(b) Look up possible corrective event actions/best practices and report concerned personnel about the action. Also look up relevant equipment information, well information and past job history and mention in the report. Decide other relevant persons concerned with this event and send them a copy of the report.

(c) If employee confirms corrective action initiation, wait for 2 hours, else notify the supervisor. If the employee reports success within 2 hours, write action to log and close case. If the wait exceeds 2 hours or the employee reports failure, perform event escalation, i.e. decide whom to notify (supervisory/managerial personnel) and report to them. If the supervisor/manager doesn't respond within 60 minutes, repeat event escalation at the next level of organizational hierarchy.

(d) Keep record of all activities and monitor key performance indicators (KPIs).

(e) Find experts from the corporate social network and discussion boards dealing with similar failures and inform them.

(f) If a new action is suggested, add it to the knowledge base.

(g) Forecast the next pump failure time based on historical data and alert the engineer in charge 6 hours earlier.

The semantic CEP framework system provides several value propositions for the enterprise. For example, in one embodiment, five key value propositions relevant to the oil and gas industry may be provided by the CEP system.

The interaction patterns among the personnel and data sources involved in an event-driven system are more efficient. The sequence of optimal enterprise integration patterns for processing a certain query is decided dynamically. The CEP engine 302A acts as the mediator for rule-driven interactions and is able to take smart decisions dynamically.

For instance, in the event of a pump failure, suppose the operator is alerted about the failure via a failure notice message promptly but due to certain circumstances, the operator saw the message later. The employee tries to take the suggested corrective action but fails and reports the failure to the employee supervisor. In this case, the employee would have to wait for the supervisor's reply. However, the supervisor might not be actively responding, or it may be the case that the concerned engineer repaired the pump successfully but missed reporting the repair. This would generate delays that could accumulate at various stages increasing the response time to the pump failure. In one embodiment, a CEP-based system can use the ‘event escalation’ pattern in such situations to avoid bottlenecks in the process and reduce the delays greatly. Event escalation refers to the concept of waiting for an action response for a certain time period, and if there is no response, automatically looking up recommended best practice for the event, implementing the best practice and alerting appropriate personnel.

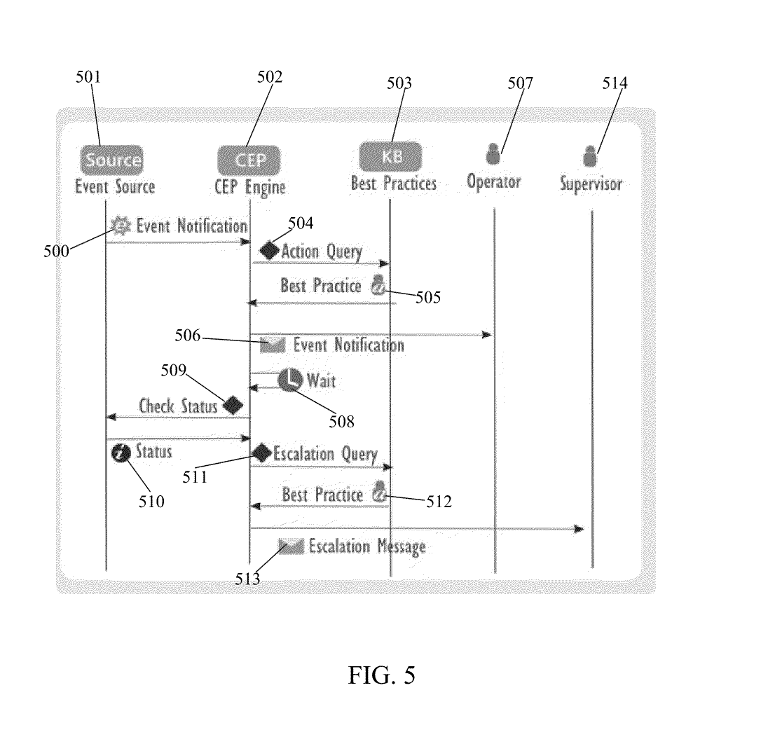

FIG. 5 is a flow diagram showing an event escalation scenario, according to an embodiment of the present invention. Event escalation is an example of one of many possible interaction patterns that can be implemented in an enterprise. Typically, several such patterns are implemented in the CEP engine 302A. These patterns can be learned over time and then used for future strategic decisions.

Referring to FIG. 5, when an event 500, such as a failure of a pump, occurs at an event source 501, the event 500 is transmitted or captured by the CEP engine 502 (e.g., CEP engine 302A). The CEP engine 502 sends an action query 504 via a query engine (e.g., query engine 302E) to knowledge base 503 (e.g., knowledge base 302D). The knowledge base 503 responds to the CEP engine 502 with a best practice action 505 from a plurality of best practices stored in the knowledge base 503. The CEP engine 502 then sends event notification 506 to operator 507. If, for some reason, the operator 507 does not respond, the CEP engine 502 waits for a predetermined period of time 508 and checks the status 509 from the source of the event 501 (e.g., checks the status of the pump that is failed). If the source of the event 501 confirms a status 510 of event 500 (e.g., no action taken). The CEP engine 502 sends an escalation query 511 to knowledge base 503 which sends back to the CEP engine 502 a best practice message 512. At which point, the CEP engine 502 sends an escalation message 513 to supervisor 514 of operator 507.

Therefore, for the example provided above, it can be seen that an event-driven framework leads to reduction in response time and reaction to events. The usual workflow for event detection systems is to detect the event, notify appropriate personnel, get corrective actions from the personnel and then suggest the actions. Since a CEP based approach can use event-condition-action rules from its knowledge base, the most likely actions can be selected automatically without manual intervention. These actions can be suggested to the personnel in charge for action (actors). If a new action is implemented, it can be added to the knowledge base for future use. Using the historical data and the knowledge base as preconditions, a CEP-based system can predict similar events in the future and notify appropriate actors before the event occurs. Such forecasting is particularly useful for predicting failures, anomalies, and management of exception events. This proactive nature of the system reduces the response time greatly as compared to conventional reactive systems. The staff member does not need to keep on checking the status of the equipment and monitoring a range of meter readings, thus leading to large improvements in response times.

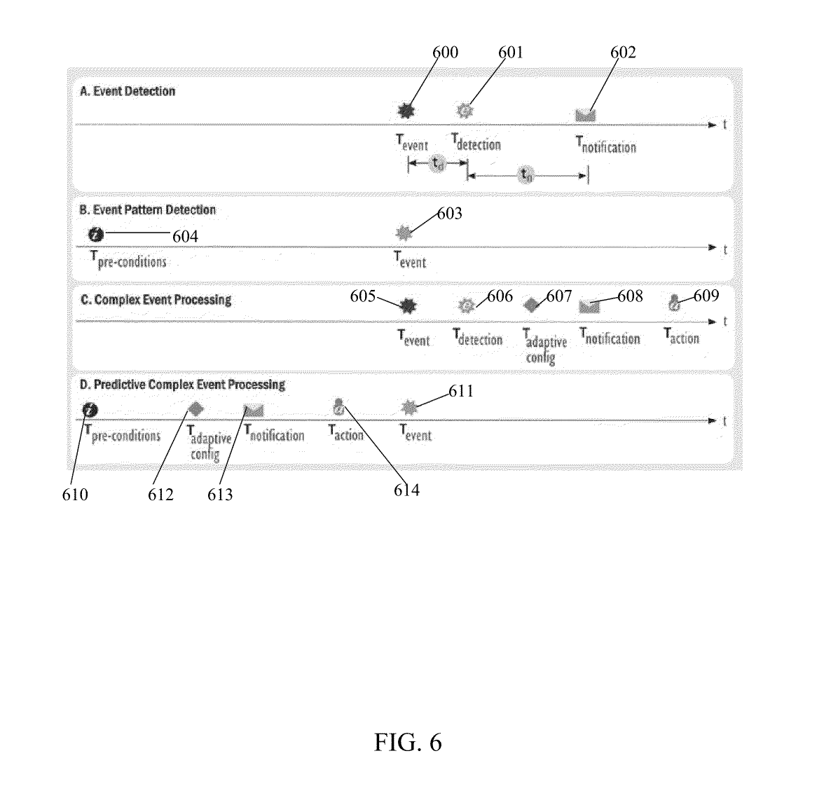

FIG. 6 is a time flow diagram depicting how proactive CEP leads to reduced delays and quicker response times, in various scenarios, according to an embodiment of the present invention. The axis represents the time and various actions are reported on this time axis as they occur at appropriate times. In scenario A, an event detection workflow is depicted. An event takes place at 600. After a certain time period, the event is detected by the system at 601. Notifications are made within a certain period of time at 602. Scenario B shows the event pattern detection workflow. The occurrence of an event (possibly a complex event) 603 is defined by a certain pattern of rules and pre-conditions 604. Based on these pre-conditions 604 and background information, it is possible to detect if the complex event has occurred or not, at 603. Scenario C incorporates complex event processing in the workflow. An event 605 may occur at a certain time and after a period of time has elapsed a detection of event occurs at 606. CEP can detect complex events at 606 as well as take an adaptive configuration at 607 to make smart decisions such as looking up corrective actions and deciding the list of persons to be notified (subscribers), at 608. After this, the notified personnel can take corrective actions to handle the event, at 609. However, in this scenario, the event, which may be a critical failure, has already taken place, and there are time delays before an action is taken. These delays include time for preprocessing and enrichment of event information, event processing by the CEP engine, search for corrective action, determination of relevant personnel and message delivery to the actor(s). Therefore, in order to enhance the CEP system, it may be desirable to prevent future failures instead of taking corrective actions to redress the failure after they have occurred. This capability can be achieved through the predictive complex event processing workflow, depicted in Scenario D. Based upon pre-conditions and contextual information, at 610, from the ontology repository 304, the predictive CEP system is able to predict future anomaly and failure events. For example, when the system detects that such an event is about to occur at 611, the CEP system can perform the adaptive configuration at 612, and notify the relevant personnel at 613 with suggested actions at 614 to prevent occurrence of the failure (before the failure occurs at 611).

Referring back to FIG. 3, data seeking efforts of the end-user can be significantly reduced with an integrated event-driven architecture. This is because all user queries are made through the CEP plugin 308A and CEP web-service 308B to the CEP engine 302A via the CEP information bus 302F, instead of querying multiple sources and contacting several staff members. The complexity of seeking relevant data can be high especially for complex queries spanning multiple resources. For instance, if an analyst wants to predict the future production from a well, the analyst may request access to the historical production data for the well, the well information system, maintenance data as well as the failure and repair job history. The analyst may not have access to the well information system, and might need to request access to an administrator. The administrator may not be actively responding to requests. In addition, the analyst's access to the data might need to be revoked after she has completed reading the data. Taking such factors into consideration, a long time period may have elapsed after the analyst request before the analyst actually obtains the desired data. Furthermore, the obtained data may be unorganized and may need sorting which adds more time to the long time period. A CEP-based system automates these processes and keeps proper records thus, minimizing the waiting time period to receive data by the end-user. The whole process may be completed in near real-time if the process is totally automated and does not require manual intervention.

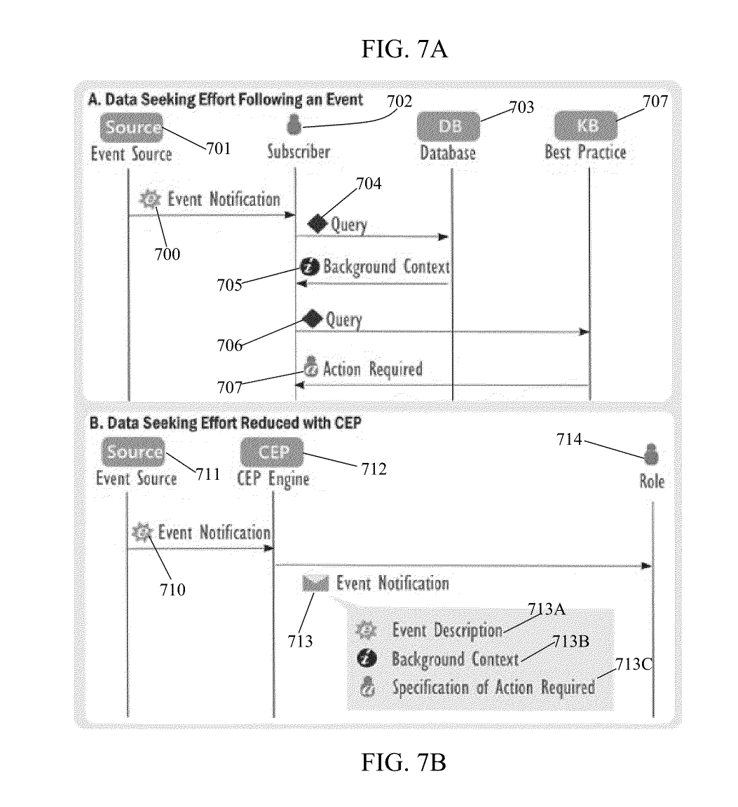

FIGS. 7A and 7B are flow diagrams showing data seeking efforts without and with using a CEP engine, respectively, according to various embodiments of the present invention.

As shown in FIG. 7A, without CEP, the user (subscriber) has to make multiple queries to data sources and knowledge bases to know the suggested action to be taken. When an event 700, such as a failure of a pump, occurs at an event source 701, the event 700 is transmitted to the subscriber 702. The subscriber 702 sends an action query 704 to database 703 (corresponding to existing information sources 306 in FIG. 3). The database 703 responds to the subscriber 702 with a background context 705. The subscriber 702, then sends query 706 to knowledge base 707. The knowledge base 707 in turn sends to the subscriber 702 an action 708 to be taken by the subscriber 702.

As shown in FIG. 7B, in a CEP framework using a CEP engine, the complex event is detected automatically, processed in the background context 705 and appropriate notifications with action specifications are made to entities 702, which have the role of subscriber, without need for human intervention. For example, when an event 710, such as a failure of a pump, occurs at an event source 711, the event 710 is transmitted or captured by the CEP engine 712 (e.g., CEP engine 302A). The CEP engine 712 sends event notification 713 to entities 714 with the role of operator. In this case, the event notification includes a description of the event 713A, the background context 713B and specification of action required 713C.

In one embodiment, a CEP-based system maintains a knowledge base of event-condition-action rules with recommended actions for specific types of events. These rules can provide the foundations of certain consistent best practices for the enterprise as well as the community. When a new rule is added to the knowledge base, it can quickly be brought into practical use at a relevant event. This ensures that all sections of the enterprise are well informed about changes in policy and avoids confusions.

In one embodiment, a CEP-based system can prioritize events and notifications based on their importance and potential impact. This ensures that the most critical events are brought into attention of the staff (e.g., operator, supervisor, engineer, etc.) early enough for immediate response, in contrast to a system that reports events chronologically. The CEP system reaches a step further in customization of the priorities according to preferences of different users. In addition, notifications for critical events can be made to multiple personnel or subscribers in different teams across the enterprise, and this list of subscribers can be generated dynamically using background knowledge. In addition, suggested actions can be displayed for the staff member to choose, and in some cases chosen automatically for corrective action.

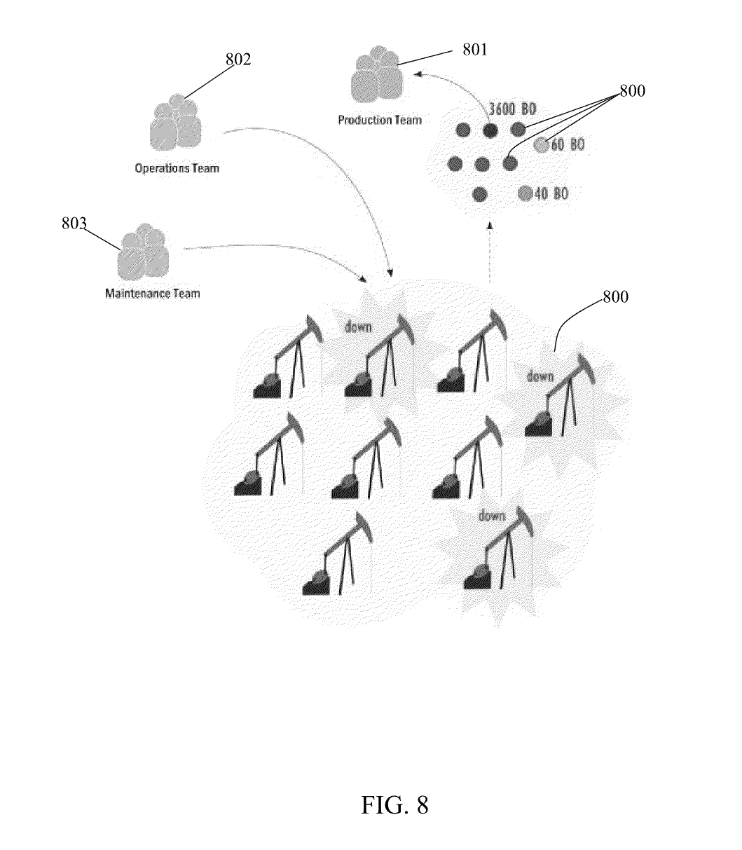

FIG. 8 is a flowchart depicting a management by exception scenario with the use of the CEP-based system, according to an embodiment of the present invention. For example, several pump failure events can be generated simultaneously throughout the enterprise when pumps 800 fail. Pumps 800 which are also depicted as dots in FIG. 8 are monitored by production team 801. Cost associated with each pump failure event can be estimated based on production rate and expected downtime.

For example, if a well producing 900 barrels of oil per day (BOPD) is down due to electrical submersible pump (ESP) failure which typically takes few days (e.g., 4 days) to repair, the cost for the well downtime would be 3600 barrels of oil (BO).

If other pump failures lead to an expected cost much lesser than 3600 barrels of oil, then the former ESP failure is the most critical failure event. The pumps 800 associated with the most critical failure event are represented in FIG. 8 with black dots. The pumps 800 associated with other less critical failure events are represented in FIG. 8 with gray dots. Therefore, in this instance, the most critical failure event should be brought to immediate attention of the staff, giving the most critical failure higher priority over other failure events. Operation team 802 and maintenance team 803 are informed of the most critical event.

As it can be appreciated from the above paragraphs, CEP systems comprise several functional components such as filtering, detection, reasoning, context awareness, analysis, prediction and notification, which can be used for enterprise information integration. A semantic CEP architecture for the digital oilfield or gas field facilitates enterprise information integration and can be successfully applied to represent and reason over complex events in an oil and gas enterprise.

Furthermore, as it can be appreciated, the term module or component or engine is used herein to encompass a hardware device, a software program, or both. For example, CEP engine 302A can be a piece of hardware that is configured to perform the CEP functions or a software program that can be run on a computer platform to perform the CEP functions, or includes both a piece of hardware and software application.

Furthermore, although each module, engine, component or element is described in the above paragraph as having a specific functionality, as it can be appreciated any functionality in one or more modules, engines, components or elements can be moved to any other one or more modules, components, engines or elements. For example, some or all functionality in the query engine 302E can be moved to the CEP engine 302A or that the functionality of the semantic query engine 302C and query engine 302E can be combined, etc.

In one embodiment, the method or system described above can be implemented as a series of instructions which can be executed by a computer. As it can be appreciated, the term “computer” is used herein to encompass any type of computing system or device including a personal computer (e.g., a desktop computer, a laptop computer, or any other handheld computing device), or a mainframe computer (e.g., an IBM mainframe), or a supercomputer (e.g., a CRAY computer), or a plurality of networked computers in a distributed computing environment.

For example, the method(s) or system may be implemented as a software program application which can be stored in a computer readable medium such as hard disks, CDROMs, optical disks, DVDs, magnetic optical disks, RAMs, EPROMs, EEPROMs, magnetic or optical cards, flash cards (e.g., a USB flash card), PCMCIA memory cards, smart cards, or other media.

Alternatively, a portion or the whole software program product can be downloaded from a remote computer or server via a network such as the internet, an ATM network, a wide area network (WAN) or a local area network.

Alternatively, instead or in addition to implementing the method as computer program product(s) (e.g., as software products) embodied in a computer, the method can be implemented as hardware in which for example an application specific integrated circuit (ASIC) can be designed to implement the method. Yet, the method can be implemented as web-based application that can be access through the internet.

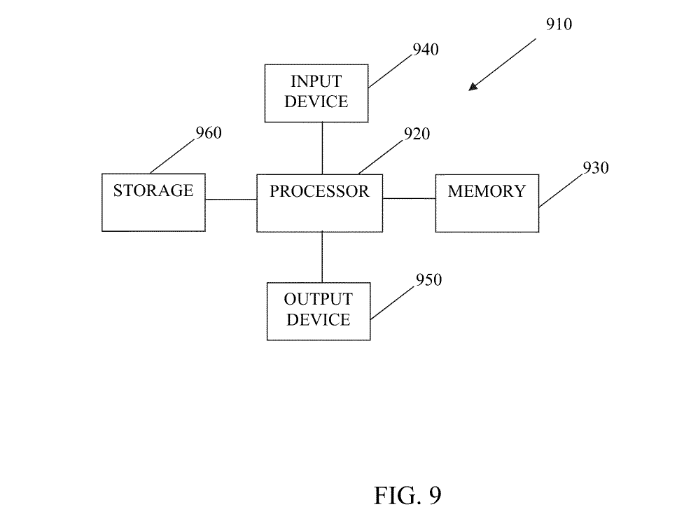

FIG. 9 is a schematic diagram representing a computer system 900 for implementing the methods or systems, according to an embodiment of the present invention. As shown in FIG. 9, computer system 910 comprises a processor (e.g., one or more processors) 920 and a memory 930 in communication with the processor 920. The computer system 910 may further include an input device 940 for inputting data (such as keyboard, a mouse or the like) and an output device 950 such as a display device for displaying results of the computation. In one embodiment, the ontology repository or knowledge base 304 resides in storage 960 associated with the computer system 910. The storage 960 includes, for example, one or more hard disks, etc. In one embodiment, the CEP components 302, which include the CEP engine 302A, event knowledge base 302D and EIP library 302B, are stored in the memory 930 associated with the computer system. In one embodiment, the processor 920 is configured to communicate with the memory 930 and execute the instructions or functions of the CEP engine described in the above paragraphs.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

Furthermore, since numerous modifications and changes will readily occur to those of skill in the art, it is not desired to limit the invention to the exact construction and operation described herein. Accordingly, all suitable modifications and equivalents should be considered as falling within the spirit and scope of the invention.

1. A complex event processing system comprising:
a complex event processing engine configured to detect one or more events across a plurality of data sources, and configured to provide a corrective action in response to the one or more events;
an ontology repository in communication with the complex event processing engine, the ontology repository being configured to receive a first semantic query from the complex event processing engine; and
an enterprise integration pattern library in communication with the complex event processing engine, the enterprise integration pattern library being configured to receive a second semantic query from the complex event processing engine.

2. The system of claim 1, wherein the complex event processing engine is configured to generate one or more semantic queries for execution over the ontology repository for inferencing and reasoning.

3. The system of claim 1, wherein the complex event processing engine is configured to handle a plurality of events in realtime with contextual filtering capabilities to retain only useful events.

4. The system of claim 1, wherein the complex event processing engine is configured to provide a corrective action or best practices for a corresponding event to appropriate personnel.

5. The system of claim 1, further comprising existing information sources including supervisory control and data acquisition database, historian database, production database, operations database, maintenance database, or equipment database, or any combination thereof, wherein the ontology repository is configured to provide a unified view of the existing information sources.

6. The system of claim 1, wherein the ontology repository comprises a complex event processing ontology component, a domain ontology component, an enterprise ontology component, or an application ontology component, or any combination thereof.

7. The system of claim 6, wherein the ontology repository has a modular configuration to enable reusability of the ontology library in another domain by changing the domain ontology, the enterprise ontology, and the application ontology.

8. The system of claim 6, wherein the ontology repository has a modular configuration to enable reusability of the ontology library in other enterprises by changing the enterprise ontology.

9. The system of claim 6, wherein the complex event processing ontology component comprises complex event processing rules, event patterns, processes, integration patterns, observations, or situations, or any combination thereof.

10. The system of claim 6, wherein the domain ontology component comprises domain concepts, properties; unit of measures, or naming standards which are specific to an enterprise, or any combination thereof.

11. The system of claim 6, wherein the enterprise ontology component comprises best practices, employee data, team composition, preferred schedules, company policies, or user rules which are specific to an enterprise, or any combination thereof.

12. The system of claim 6, wherein the application ontology component comprises schemas, equipment attributes, application views, or key performance indicators which are specific to a vendor product, or any combination thereof.

13. The system of claim 6, wherein the complex event processing engine is configured to generate one or more semantic queries for execution over the ontology repository, the one or more semantic queries are configured to read information from multiple data sources or ontologies in the ontology repository.

14. The system of claim 13, wherein concepts related to time and space are obtained from the complex event processing ontology component.

15. The system of claim 13, wherein an event, a concept, or rule, or any combination thereof is obtained from the application ontology component.

16. The system of claim 13, wherein best practices for an event are extracted from the enterprise ontology component.

17. The system of claim 1, further comprising an event knowledge base in communication with the complex event processing engine, the event knowledge base being configured to perform data mining and to perform semantic enrichment of data retrieved from the plurality of data sources using background knowledge from the ontology repository.

18. The system of claim 17, wherein the event knowledge base comprises information about possible types of events in an enterprise and a way in which the events are related to other resources including individual, teams, schedules, roles, processes, or key performance indicators, or any combination thereof.

19. The system of claim 1, further comprising a query engine in communication with the complex event processing engine, the query engine being configured to execute one or more queries over one or more databases and communicate results of the one or more queries back to the complex event processing engine.

20. The system of claim 1, further comprising a data access component in communication with the complex event processing engine, the data access component being configured to receive a query from a user and transfer the query to the complex event processing engine.

21. The system of claim 1, wherein the complex event processing engine is configured to automatically detect a complex event and to process the complex event using a background context retrieved from the ontology repository.

22. The system of claim 1, wherein the enterprise integration pattern library comprises message routing patterns, message transformation patterns and message management patterns.

23. The system of claim 22, wherein the message routing patterns comprise content-based router, message filter, splitter, aggregator, re-sequencer, or composed message processor, or any combination thereof.

24. The system of claim 22, wherein the message transformation patterns comprise content enricher, content filter, message translator, envelope wrapper, claim check, or normalizer, or any combination thereof.

25. The system of claim 22, wherein the message management patterns include wire tap, control bus, message store, channel purger, detour, or message history, or any combination thereof.

26. The system of claim 1, wherein the complex event processing engine is configured to determine integration patterns needed for processing specific events, and to retrieve the integration patterns from the enterprise integration pattern library.

27. The system of claim 1, wherein the enterprise integration pattern library is configured to manage a lifecycle of integration patterns during a complex event process.

28. The system of claim 1, further comprising a complex event processing information bus in communication with the complex event processing engine, the complex event processing information bus being configured for inputting data into or outputting data from the complex event processing engine.

29. The system of claim 28, further comprising a complex event processing web-service in communication with the complex event processing information bus, the complex event processing web-service being configured to provide web access to features enabled by the complex event processing system.

30. The system of claim 1, wherein the complex event processing engine is configured to suggest corrective action before a failure event occurs using predictive analytics methods, reasoning and access to historical data.
